(19) United States
(12) Patent Application Publication
(10) Pub. No.: US 2005/0174378 A1
(43) Pub. Date: Aug. 11, 2005

(54) Fixing and ejecting device

(76) Inventor: Kuo-Ping Lu, Danshuei Township (TW)

Correspondence Address: RABIN & Berdo, PC, 1101 14TH STREET, NW, SUITE 500, WASHINGTON, DC, 20005, US

(21) Appl. No.: 11/036,356

(22) Filed: Jan. 18, 2005

(30) Foreign Application Priority Data
Feb. 11, 2004 (TW) 93103253

(51) Int. Cl. B41J 29/393

(52) U.S. Cl. 347/19

(57) ABSTRACT

A fixing and ejecting device disposed within the casing of an electronic device and integrated with a stylus is provided. The fixing and ejecting device comprises a pair of retaining arms, a junction portion and a spring piece. The junction portion is for connecting the pair of retaining arms. The pair of retaining arms disposed at one side of the inner surface of the casing for accommodating the stylus are elastically deformed to retain the stylus for the stylus to be fixed within the casing. The spring piece formed on the junction portion corresponds to the stylus. By applying an external force onto the stylus, the spring piece is compressed by the stylus and becomes elastically deformed. So that, the spring piece provides an elastic applying force to the tip of the stylus and the stylus can be ejected from the pair of retaining arms.

This application claims the benefit of Taiwan application Serial No. 93103253, filed Feb. 11, 2004, the subject matter of which is incorporated herein by reference.

### BACKGROUND OF THE INVENTION

1. Field of the Invention

The invention relates in general to a fixing and ejecting device, and more particularly to a fixing and ejecting device used in an electronic device.

2. Description of the Related Art

Modern people who are busy with their daily lives have to keep a record or make arrangements of a lot of telephone numbers, addresses, appointments, minutes or schedules. Electronic devices such as personal digital assistant (PDA), the electronic secretary used by business people first, with the features of being small, slim, light and compact and the capacities of artificial intelligence such as word and pattern recognition is virtually like a mini computer, can do a lot to make modern people's lives easier. In response to the rapid development of Internet and e-mail, the PDA is also capable of Internetting and e-mailing, making information portable to the user. The PDA is becoming more and more important to modern people's lives.

Apart from the features of being small, slim, compact and portable, special man-machine interfaces such as touch-control screen, stylus input method further improve the convenience of PDA in terms of use. The user only needs to press a few press-keys if the user would like to have a browse of the to-do list. The user can also input things-to-do to the PDA with a stylus.

Referring to FIG. 1, a decomposition diagram of the fixing and ejecting device of the stylus of a conventional PDA is shown. The conventional fixing and ejecting device of the stylus mainly comprises a fixing mechanism 10 and an ejecting mechanism 20 which are separate to each other. A back cover 114 of the PDA has a slide channel 116 and a compression channel 118 disposed therein for accommodating a stylus 100. A fixing mechanism 10 and an ejecting mechanism 20 are respectively disposed at the two ends of the slide channel 116, while the distance between the fixing mechanism 10 and the ejecting mechanism 20 is physically equal to the length of the stylus 100.

Of which, the fixing mechanism 10, which is adhered to a printed circuit board (not shown here), uses a positioning element 102 to fasten the stylus 100 placed therein. The fixing mechanism 10 comprises a positioning element 102, a base unit 104 and a torque spring 106. The base unit 104 has a spindle 107 disposed thereon for coupling the positioning element 102. The torque spring 106 is disposed between the base unit 104 and the positioning element 102. The ejecting mechanism 20 comprises a slide plate 108, a spring 110 and a covering plate 112. Of which, the covering plate 112 is coupled to the inner side of the back cover 114, wherein the space between the covering plate 112 and the back cover 114 forms a compression channel 118 for accommodating the slide plate 108 and the spring 110 coupled to the bottom of the slide plate 108. The ejecting mechanism 20 uses the anti-thrust generated by the elastic restoring force of the compressed spring 110, so that the stylus 100 is indirectly driven by the slide plate 108 to be ejected upwardly along the slide channel 116.

Please refer to both FIG. 1 and FIG. 2. FIG. 2 is a schematic diagram of the operation of a conventional fixing and ejecting device. The positioning element 102 of the fixing mechanism 10 further comprises a press-button 200 and a guiding arm 204. When the stylus 100 is placed at the slide channel 116, the guiding arm 204 will be fit into the groove 206 of the stylus 100 to fix the stylus 100. That is to say, the fixing mechanism 10 retains the stylus 100 via a coupling mechanism. The stylus has its tip 208 abut the slide plate 212 downwardly so as to indirectly compress the spring 110 disposed within the compression channel 118, making the spring 110 compressed. Meanwhile, the upward elastic restoring force generated by the spring 110 balances the downward pressure generated when the stylus 100 is retained at the fixing mechanism 10.

If the stylus 100 needs to be released, the user can apply an external force F1 onto the press-button 200, so that the positioning element 102 will rotate clockwise using the spindle 107 disposed on the base unit 104 as a rotary spindle. By doing so, the positioning element 102 can drive the guiding arm 204 to move downwardly and withdraw the guiding arm 204 from the groove 206 of the stylus 100. Meanwhile, the torque generated by the elastic restoring force of the compressed torque spring 106 will resume the positioning element 102 to its original position. When the stylus 100 looses the downward pressure when retained at the fixing mechanism 10, the upward elastic restoring force of the compressed spring 110 will become an anti-thrust. The anti-thrust will drive the slide plate 108 to move upwardly along the compression channel 118 and indirectly withdraw the tip 208 from the compression channel 118; meanwhile, the stylus 100 will be ejected upwardly along the slide channel 116.

To summarize, although the conventional fixing and ejecting device is able to have the stylus fixed within and released from an electronic device, a larger number of elements are needed and the costs involved are higher. Furthermore, since more elements are needed, longer assembly time will be required. Besides, displacements of elements are likely to occur after disassembly, making it difficult to assemble the elements again. Given the ejecting mechanism and the fixing mechanism are disposed on the back cover at the corresponding position of the stylus' tip and terminal, the conventional fixing and ejecting device requires a larger space. This will increase the volume of an electronic device such as a PDA and impair PDA's features of being small, slim, light and compact.

### SUMMARY OF THE INVENTION

It is therefore an object of the invention to provide a fixing and ejecting device for effectively reducing the number of elements, so that the element costs, the time and efforts required for the assembly of elements can be reduced. Furthermore, the assembly of elements can have a better precision and a smaller assembly space, hence improving the PDA's features of being small, slim, light and compact.

The invention achieves the above-identified object by providing a fixing and ejecting device, which is disposed within the casing of an electronic device and integrated with the stylus. The fixing and ejecting device mainly comprises a pair of retaining arms, a junction portion and a spring piece. The junction portion is for connecting the pair of retaining arms. The pair of retaining arms, which are disposed at one side of the inner surface of the casing for accommodating the stylus, are elastically deformed to retain the stylus for the stylus to be fixed within the casing. The spring piece, which is formed on the junction portion, corresponds to the stylus. Of which, by applying an external force onto the stylus, the spring piece will be compressed by the stylus and become elastically deformed; meanwhile, the spring piece, which has been elastically deformed, will provide an elastic applying force to the tip of the stylus so that the stylus can be ejected from the pair of retaining arms.

Of which, the stylus can have a ring-shaped indention whereby the pair of retaining arms retains the stylus. Moreover, the casing can have a hole, which corresponds to the fixing and ejecting device and provides a passage via which the stylus can be placed at the fixing and ejecting device or ejected from the casing. The peripheral of the hole can have recesses disposed therein facilitating the external force to be applied onto the stylus. The inner side of the casing can further have an installation base formed therein, wherein the fixing and ejecting device can be disposed at the installation base. The installation base can further have a fixing piece formed therein, wherein the fixing piece protrudes into the inter-space between the fixing device and the ejecting device for the fixing device and the ejecting device of stylus to be fixed at the installation base firmly. The electronic device can be a PDA. The spring piece can be replaced by an elastic portion such as a spring.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a decomposition diagram of the fixing and ejecting device of the stylus of a conventional PDA;

FIG. 2 is a schematic diagram of the operation of a conventional fixing and ejecting device;

FIG. 3A is a schematic diagram of a fixing and ejecting device according to a preferred embodiment of the invention;

FIG. 3B is a front view of the fixing and ejecting device in FIG. 3A;

FIG. 3C is a top view of the fixing and ejecting device in FIG. 3A;

FIG. 3D is a cross-sectional view along the crossing line 3D-3D in FIG. 3C;

FIG. 4A shows the status when a fixing and ejecting device is disposed within the casing of a PDA;

FIG. 4B is a partial enlargement of FIG. 4A;

FIG. 4C a schematic diagram of stylus;

FIG. 5A is a corresponding schematic diagram of FIG. 4A when an external force is applied onto the stylus;

FIG. 5B is a partial enlargement of FIG. 5A;

FIG. 6A is a schematic diagram of an installation base 430 with a fixing piece 435 formed at the inner side thereof;

FIG. 6B is a partial enlargement of FIG. 6A;

FIG. 6C is a schematic diagram showing the fixing and ejecting device300 is set at the installation base 430 firmly;

FIG. 6D is a partial enlargement of FIG. 6C;

FIG. 6E is a side view showing the integration between the installation base 430, the inter-space 322 and the fixing piece 435;

FIG. 7 is a schematic diagram of a hole with recess disposed at the peripheral thereof;

FIG. 8 is a diagram showing the manufacturing process of the fixing and ejecting device; and

FIG. 9 is a schematic diagram of the fixing and ejecting device according to another preferred embodiment of the invention.

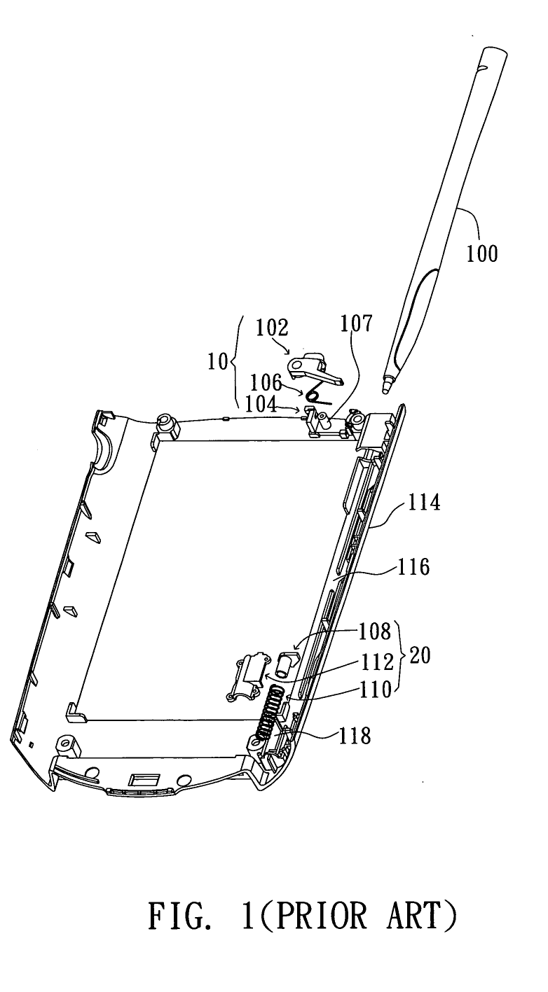

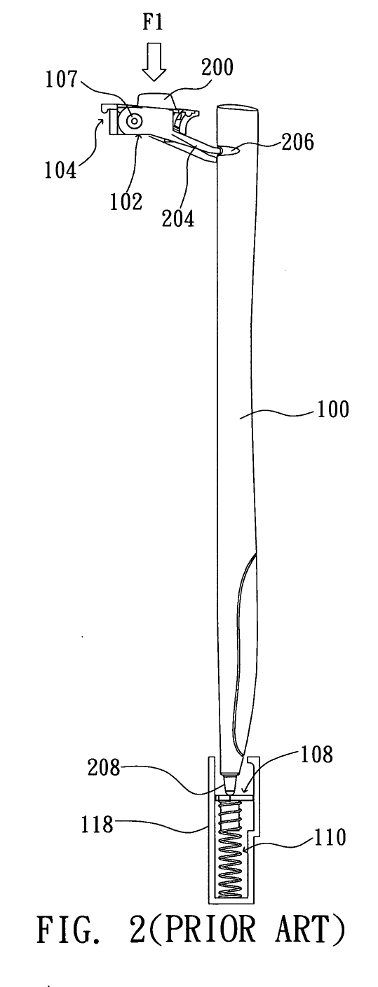

### DETAILED DESCRIPTION OF THE INVENTION

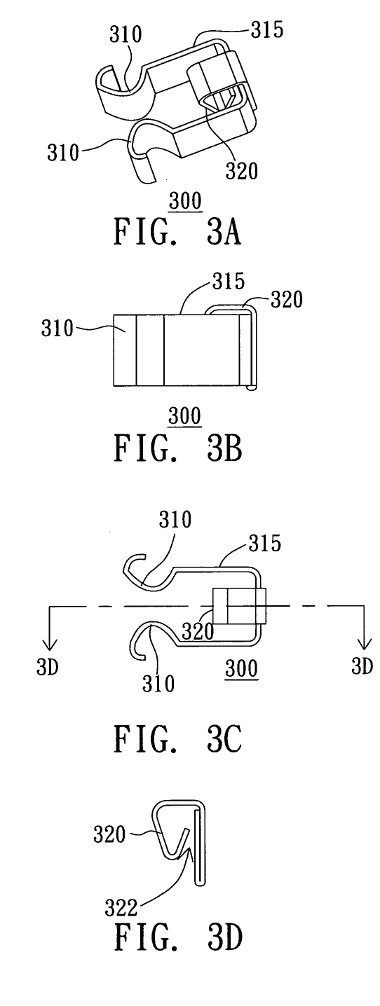

Refer to FIGS. 3A, 3B, 3C and 3D as a whole. FIG. 3A is a schematic diagram of a fixing and ejecting device according to a preferred embodiment of the invention; FIG. 3B is a front view of the fixing and ejecting device in FIG. 3A; FIG. 3C is a top view of the fixing and ejecting device in FIG. 3A; and FIG. 3D is a cross-sectional view along the crossing line 3D-3D in FIG. 3C. The stylus' fixing and ejecting device 300 mainly comprises a pair of retaining arms 310 and an elastic portion such as a spring piece 320. Of the fixing and ejecting device 300, the pair of retaining arm 310 is jointed via a junction portion 315, while the spring piece 320 is formed on the junction portion 315.

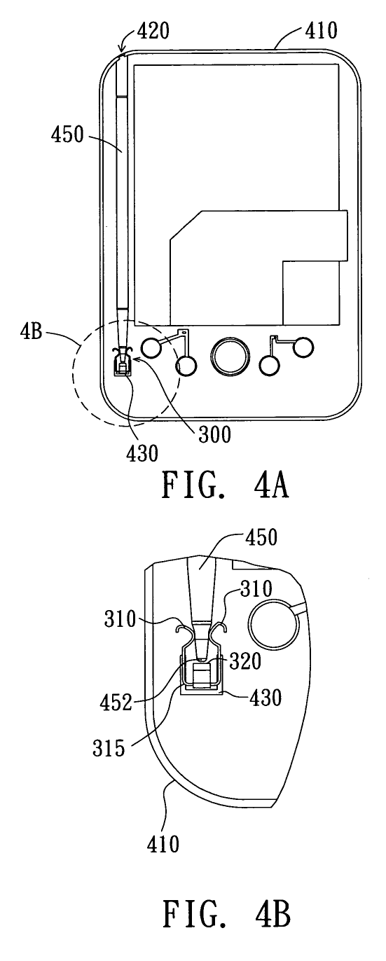

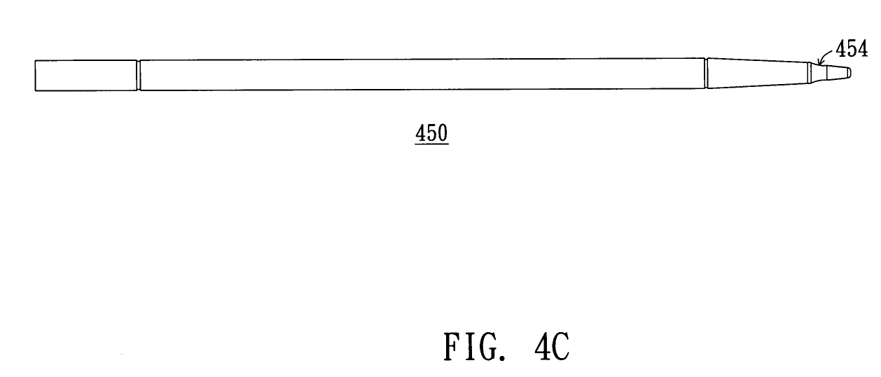

Please refer to FIGS. 4A, 4B and 4C as a whole. FIG. 4A shows the status when a fixing and ejecting device is disposed within the casing of a PDA; FIG. 4B is a partial enlargement of FIG. 4A; and FIG. 4C a schematic diagram of stylus. The stylus' fixing and ejecting device 300 is disposed within a casing 410 of an electronic device such as a personal digital assistant (PDA) and is integrated with a stylus 450.

The stylus' fixing and ejecting device 300 is disposed within the installation base 430, which is formed on one side of the inner surface of the casing 410. A hole 420 via which the stylus 450 is placed into or ejected from the casing 410 is disposed on another side of the casing 410 to be corresponding to the stylus' fixing and ejecting device 300. The stylus 450 has a ring-shaped indention 454 which surrounds the shaft of the stylus 450 and is close to the tip of the stylus 450. The pair of retaining arms 310 for accommodating the stylus 450 can be elastically deformed to retain the stylus 450 via the ring-shaped indention 454 to fix the stylus 450 within the casing 410 firmly. The spring piece 320, which corresponds to the tip 452 of the stylus 450, will be compressed by the stylus 450 so as to accumulate an elastic force when the stylus 450 is placed within the casing 410 and is retained by the pair of retaining arms 31. That is to say, the spring piece 320 is for generating an elasticity which is capable of at least ejecting the stylus 450 from the pair of retaining arms 310.

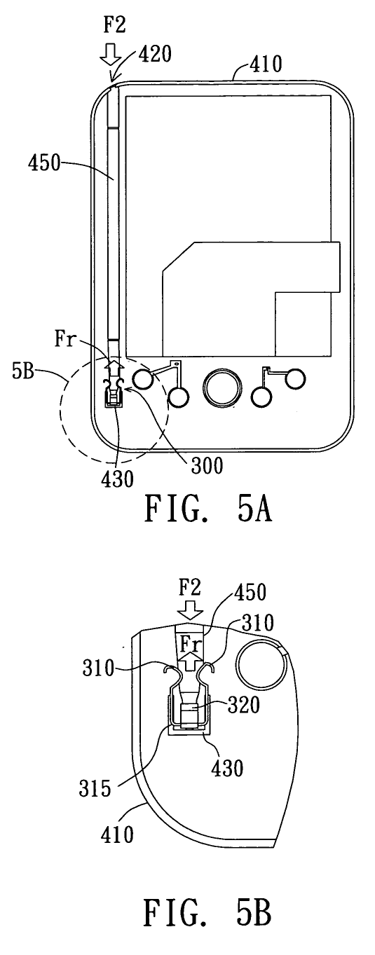

Please refer to both FIG. 5A and FIG. 5B. FIG. 5A is a corresponding schematic diagram of FIG. 4A when an external force is applied onto the stylus; FIG. 5B is a partial enlargement of FIG. 5A. By applying an external force F2 onto the stylus 450, the spring piece 320 will be compressed by the tip and become elastically deformed. The spring piece 320, being elastically deformed, will provide an elastic applying force Fr to the tip, so that the stylus 450 can be ejected from the pair of retaining arms 310. The function of the hole 420 is to provide a passage via which via which the stylus 450 can be placed into the stylus' fixing and ejecting device 300 or ejected from the casing 410.

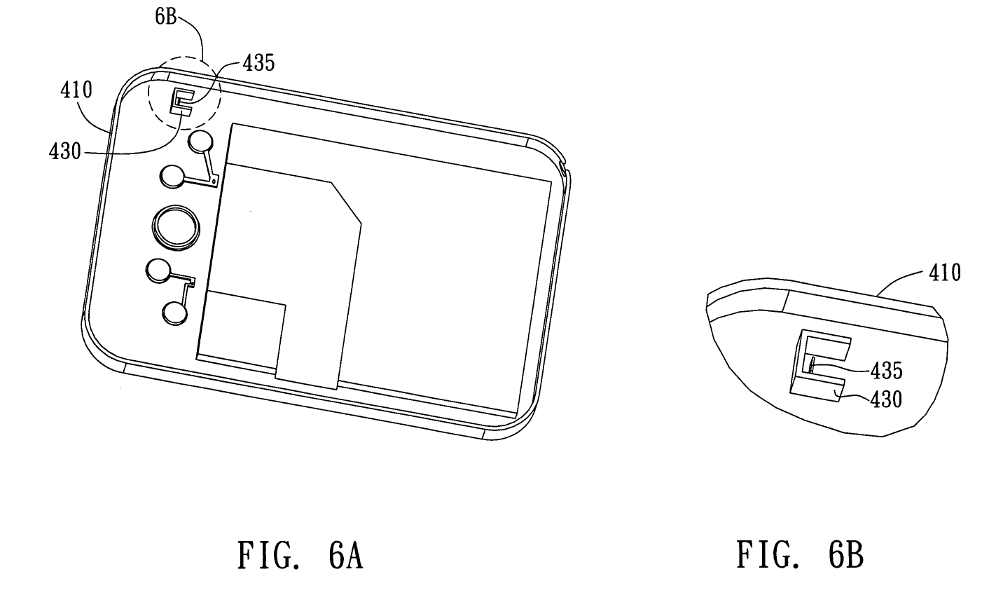

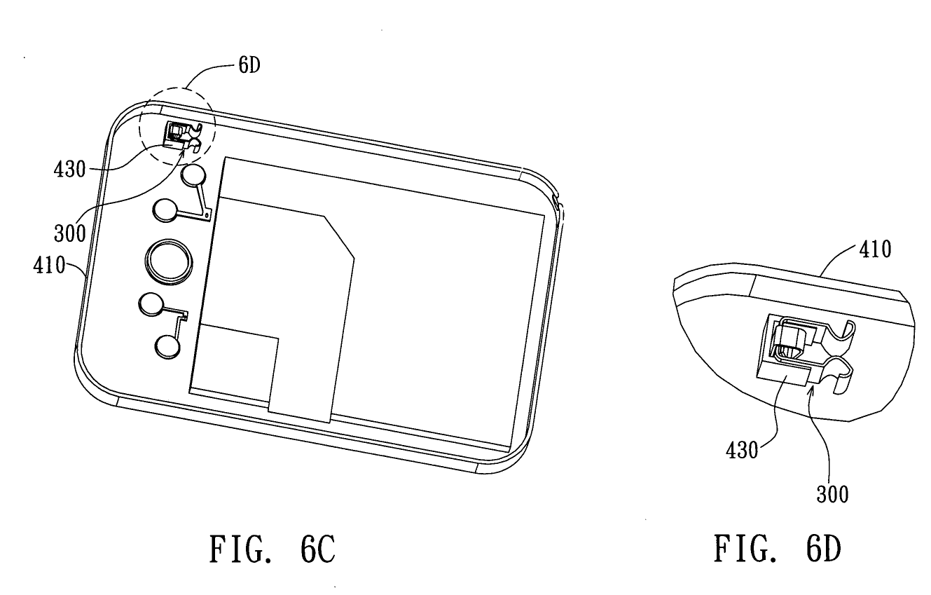

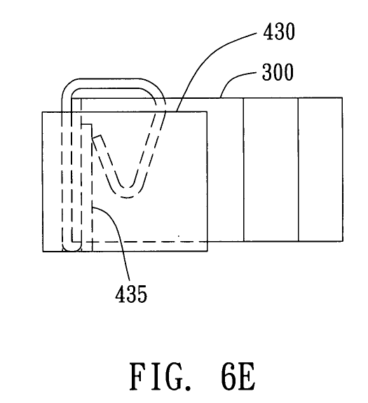

Please refer to FIGS. 6A, 6B, 6C, 6D and 6E as a whole. FIG. 6A is a schematic diagram of an installation base 430 with a fixing piece 435 formed at the inner side thereof; FIG. 6B is a partial enlargement of FIG. 6A; FIG. 6C is a schematic diagram showing the fixing and ejecting device 300 is set at the installation base 430 firmly; FIG. 6D is a partial enlargement of FIG. 6C; and FIG. 6E is a side view showing the integration between the installation base 430, the inter-space 322 and the fixing piece 435. The stylus' fixing and ejecting device 300 is disposed within the installation base 430. A fixing piece 435, which is formed on the inner side of the installation base 430 disposed on the inner surface of the casing 410, protrudes into an inter-space like the inter-space 322 of the spring piece 320 shown in FIG. 3D for the stylus' fixing and ejecting device 300 to be fixed at the installation base 430 firmly as shown in FIG. 6D.

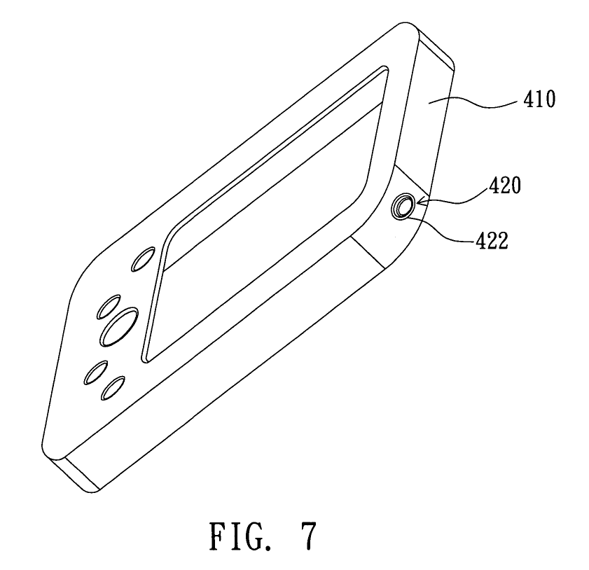

Referring to FIG. 7, a schematic diagram of a hole with recess disposed at the peripheral thereof is shown. To tackle with the inconvenience for an external force to be applied onto the stylus 450 via the hole 420, a recess 422 is disposed at the peripheral of the hole 420 on the casing 410, so that the external force can be easily applied onto the stylus.

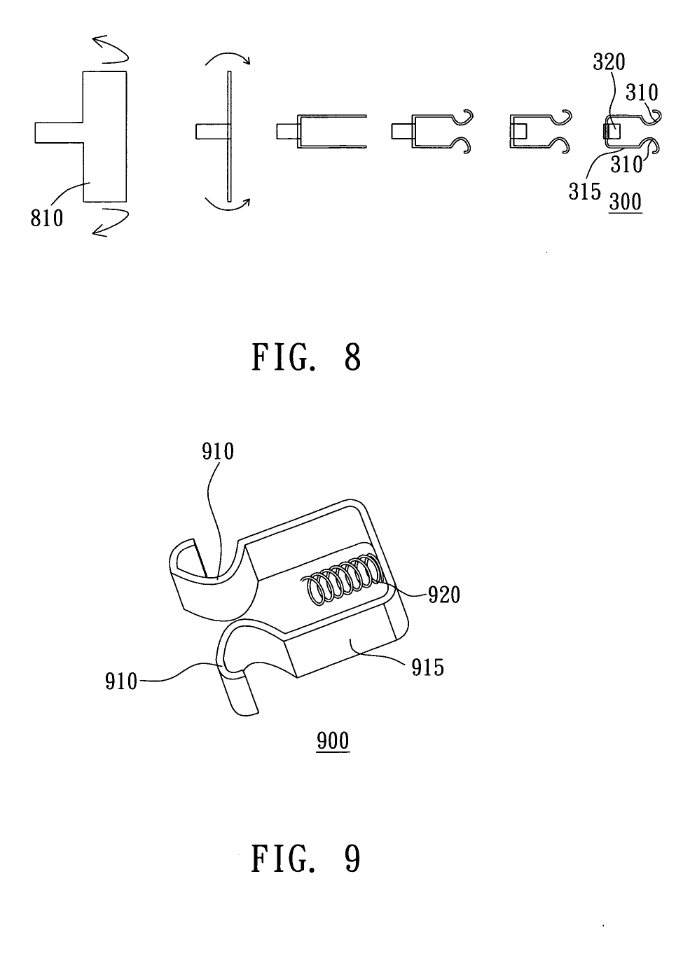

Besides, the stylus' fixing and ejecting device 300 according to the invention is easy to manufacture. Referring to FIG. 8, a diagram showing the manufacturing process of the fixing and ejecting device is shown. In the diagram of the manufacturing process, the pre-cut metal piece 810, after going through the sequential process of folding and pressing, can be molded into the stylus' fixing and ejecting device 300 comprising a pair of retaining arms 310, a junction portion 315 and a spring piece 320 in one block.

The electronic device disclosed in the above preferred embodiments according to the invention is not limited to a PDA. The fixing and ejecting device according to the junction portion invention can be applied to any electronic device integrated with a stylus and disposed within the casing of the electronic device.

Provided that the function of the stylus' fixing and ejecting device 300 according to the function is not affected, the elastic portion can be a general spring other than the spring piece 320. Referring to FIG. 9, a schematic diagram of the fixing and ejecting device according to another preferred embodiment of the invention is shown. The stylus' fixing and ejecting device 900 comprises a pair of retaining arms 910, a junction portion 915 and a spring 920. The junction portion 915 is for connecting the pair of retaining arms 910. The spring 920 is connected with the junction portion 915 and corresponds to the stylus' tip. The spring 920, like the spring piece 320, can be compressed by the stylus' tip and become elastically deformed. The spring 920, which has been elastically deformed, provides an elastic applying force to the tip of the stylus so that the stylus can be ejected from the pair of retaining arms 910.

To summarize, the fixing and ejecting device disclosed in the above preferred embodiments according to the invention at least has the following advantages of:
1. costing less in terms of material cost and parts cost because only one element is needed;
2. reducing assembly time and assembly cost because only one element is involved;
3. preventing displacement of elements after disassembly and enabling assembly easier;
4. occupying a smaller space compared with a conventional fixing and ejecting device so that the volume of an electronic device such as a PDA can be further reduced further improving the features of being small, slim, light and compact.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A fixing and ejecting device disposed within a casing of an electronic device for fixing and ejecting a stylus, wherein the fixing and ejecting device at lease comprises:
a pair of retaining arms, which can be elastically deformed to retain the stylus;
a junction portion for connecting the pair of retaining arms; and
an elastic portion connected with the junction portion for providing an elastic force at east capable of ejecting the stylus from the pair of retaining arms.

2. The fixing and ejecting device according to claim 1, wherein the elastic portion is a spring piece, which corresponds to the stylus.

3. The fixing and ejecting device according to claim 1, wherein the elastic portion is a spring.

4. The fixing and ejecting device according to claim 1, wherein the stylus further has a ring-shaped indention whereby the pair of retaining arms retain the stylus.

5. The fixing and ejecting device according to claim 1, wherein the casing has a hole, which corresponds to the fixing and ejecting device and provides a passage via which the stylus can be placed at the fixing and ejecting device or ejected from the casing.

6. The fixing and ejecting device according to claim 5, wherein the peripheral of the hole has a recess.

7. The fixing and ejecting device according to claim 1, wherein the fixing and ejecting device is disposed within an installation base formed on the inner surface of the casing.

8. The fixing and ejecting device according to claim 7, wherein a fixing piece is formed on the inner side of the installation and protrudes into an inter-space formed between the fixing device and the ejecting device for the fixing device and the ejecting device of stylus to be fixed at the installation base firmly.

9. The fixing and ejecting device according to claim 1, wherein the electronic device is a personal digital assistant (PDA).

10. An electronic device, comprising:
a casing;
a pair of retaining arms, which is disposed within the casing and can be elastically deformed to retain a stylus;
a junction portion for connecting the pair of retaining arms; and
an elastic portion formed on the junction portion for providing an elastic force at east capable of ejecting the stylus from the pair of retaining arms.

11. The electronic device according to claim 10, wherein the elastic portion is a spring piece which corresponds to the stylus.

12. The electronic device according to claim 10, wherein the elastic portion is a spring.

13. The electronic device according to claim 10, wherein, the stylus further has a ring-shaped indention whereby the pair of retaining arms retains the stylus.

14. The electronic device according to claim 10, wherein the casing has a hole, which corresponds to the fixing and ejecting device and provides a passage via which the stylus can be placed at the fixing and ejecting device or ejected from the casing.

15. The electronic device according to claim 14, wherein the peripheral of the hole has a recess.

16. The electronic device according to claim 10, wherein the inner surface of the casing has an installation base in which the pair of retaining arms, the junction portion and the elastic portion are disposed.

17. The electronic device according to claim 10, wherein the electronic device is a PDA.
